(19) United States
(12) Patent Application Publication
(10) Pub. No.: US 2024/0079740 A1
(43) Pub. Date: Mar. 7, 2024

(54) METHOD OF ASSEMBLING TRACTION BATTERY PACK AND TRACTION BATTERY PACK ASSEMBLY

(71) Applicant: Ford Global Technologies, LLC, Dearborn, MI (US)

(72) Inventor: Deanna Marie Winton Hoffman, Ann Arbor, MI (US)

(21) Appl. No.: 18/162,898

(22) Filed: Feb. 1, 2023

Related U.S. Application Data
(60) Provisional application No. 63/403,445, filed on Sep. 2, 2022.

(51) Int. Cl. H01M 50/553; H01M 10/0525; H01M 50/211; H01M 50/566

(52) U.S. Cl. CPC H01M 50/553; H01M 10/0525; H01M 50/211; H01M 50/566; H01M 2220/20

(57) ABSTRACT

A method of assembling a battery pack includes bending at least one first tab terminal of at least one first battery cell and then positioning the at least one first battery cell along an axis of a cell stack. The method also includes bending at least one second tab terminal of at least one second battery cell and then positioning the at least one second battery cell along the axis of the cell stack. After the bending, the method secures the at least one first tab terminal to the at least one second tab terminal.

### CROSS-REFERENCE TO RELATED APPLICATIONS

This application claims priority to U.S. Provisional Application No. 63/403,445, which was filed on 2 Sep. 2022 and is incorporated herein by reference.

### TECHNICAL FIELD

This disclosure relates generally to electrically connecting battery cells of a traction battery pack.

### BACKGROUND

A traction battery pack of an electrified vehicle can include groups of battery cells arranged in one or more cell stacks. At least some of the battery cells can be electrically connected together.

### SUMMARY

In some aspects, the techniques described herein relate to a method of assembling a battery pack, including: bending at least one first tab terminal of at least one first battery cell and then positioning the at least one first battery cell along an axis of a cell stack; bending at least one second tab terminal of at least one second battery cell and then positioning the at least one second battery cell along the axis of the cell stack; and securing the at least one first tab terminal to the at least one second tab terminal after bending the at least one first tab terminal and the at least one second tab terminal.

In some aspects, the techniques described herein relate to a method, wherein the securing electrically connects the at least one first tab terminal to the at least one second tab terminal.

In some aspects, the techniques described herein relate to a method, further including securing the at least one first tab terminal to the at least one second tab terminal with at least one weld.

In some aspects, the techniques described herein relate to a method, further including, prior to the securing, inserting a backer tower between the at least one first tab terminal and a case of the at least one first battery cell, and between the at least one second tab terminal and a case of the at least one second battery cell.

In some aspects, the techniques described herein relate to a method, further including securing the at least one first tab terminal to the at least one second tab terminal by welding against the backer tower.

In some aspects, the techniques described herein relate to a method, wherein the at least one first tab terminal extends from a case of the at least one first battery cell in a direction, wherein bending the at least one first tab terminal is a bending with reference to the direction.

In some aspects, the techniques described herein relate to a method, wherein, after bending the at least one first tab terminal, portions of the at least one first tab terminal extend axially in a first direction, wherein, after bending the at least one second tab terminal, portions of the at least one second tab terminal extend axially in a second direction opposite the first direction.

In some aspects, the techniques described herein relate to a method, wherein, after bending the at least one first tab terminal, portions of the at least one first tab terminal are oriented perpendicular to other portions of the at least one first tab terminal.

In some aspects, the techniques described herein relate to a method, further including, after the securing, positioning a cross-member adjacent the at least one first tab terminal and the at least one second tab terminal such that the at least one first tab terminal and the at least one second tab terminal are sandwiched between the cross-member and cases of the at least one first battery cell and the at least one second battery cell.

In some aspects, the techniques described herein relate to a method, wherein the at least one second tab terminal is on a first side of the cell stack, and further including securing at least one second tab terminal on an opposite, second side of the at least one second battery cell to at least one third tab terminal of at least one third battery cell.

In some aspects, the techniques described herein relate to a method, further including, prior to securing the at least one second tab terminal on the second side to the at least one third tab terminal, bending the at least one second tab terminal on the second side, and bending the at least one third tab terminal.

In some aspects, the techniques described herein relate to a method, wherein the at least one first battery cell and the at least one second battery cell are battery cells of a traction battery pack.

In some aspects, the techniques described herein relate to a method, wherein the at least one first battery cell and the at least one second battery cell are lithium-ion pouch cells.

In some aspects, the techniques described herein relate to a method, wherein the at least one first battery cell includes two first battery cells each having one first tab terminal, and the at least one second battery cell includes two second battery cells each having one second tab terminal.

In some aspects, the techniques described herein relate to a method, wherein the securing includes securing the first tab terminals of the two first battery cells directly to the second tab terminals of the two second battery cells.

In some aspects, the techniques described herein relate to a battery pack assembly, including: a first battery cell having a first tab terminal extending from a first case; a second battery cell having a second tab terminal extending from a second case; and a cross-member, the first and second tab terminals joined to each other and sandwiched between the cross-member and the first and second cases.

In some aspects, the techniques described herein relate to a battery pack assembly, wherein the first and second battery cells are lithium-ion pouch cells.

In some aspects, the techniques described herein relate to a battery pack assembly, wherein the first and second tab terminals are directly joined to each other with at least one weld.

In some aspects, the techniques described herein relate to a battery pack assembly, wherein the first and second battery cells are constituents of a traction battery pack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 2 according to an exemplary embodiment of the present disclosure.

FIG. 3 illustrates a battery cell from the battery pack of FIG. 2.

FIG. 4 illustrates the battery cell of FIG. 3 after bending a tab terminal of the battery cell.

FIGS. 5A and 5B illustrate respective top and side views of a pair of first battery cells positioned to provide one of the cells stacks for the battery pack of FIG. 2 according to the exemplary embodiment.

FIGS. 6A and 6B illustrate respective top and side views of the battery cells of FIGS. 5A and 5B along with a pair of second battery cells positioned to provide the cell stack.

FIGS. 7A and 7B illustrate respective top and side views of the battery cells of FIGS. 6A and 6B positioned along with the remaining battery cells of the cells stack.

FIGS. 8A and 8B illustrate respective top and side views of the battery cells of FIGS. 7A and 7B as terminals of the pair of first battery cells are joined to terminals of the pair of second battery cells and with cross-members shown in FIG. 8A.

### DETAILED DESCRIPTION

This disclosure details exemplary methods of assembling a traction battery pack and, in particular, methods of electrically connecting tab terminals of battery cells within the traction battery pack. The disclosure additionally details exemplary battery packs that are assembled using these methods.

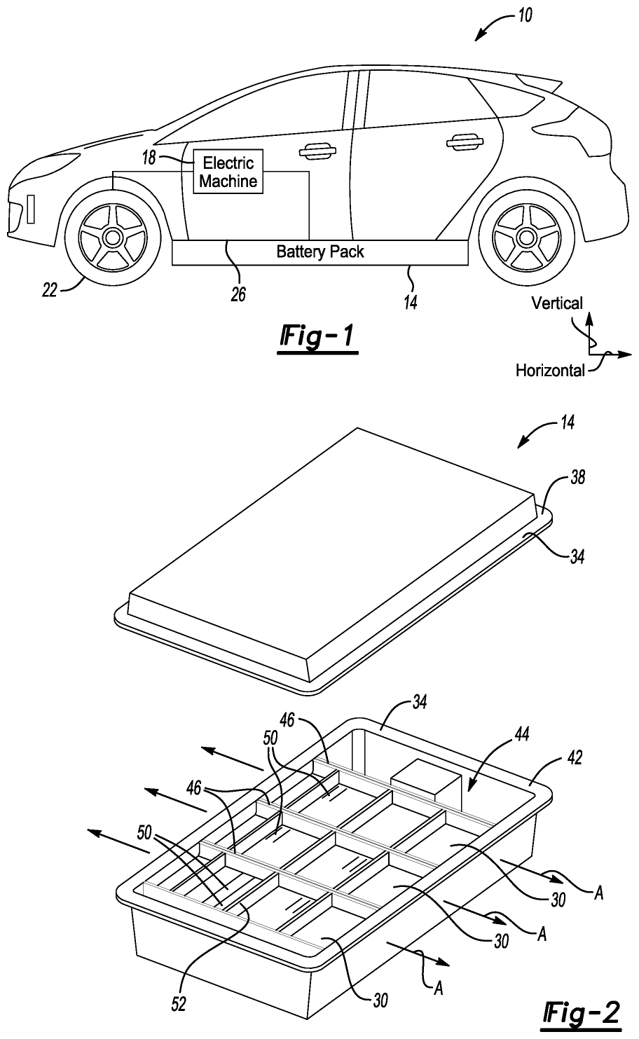

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

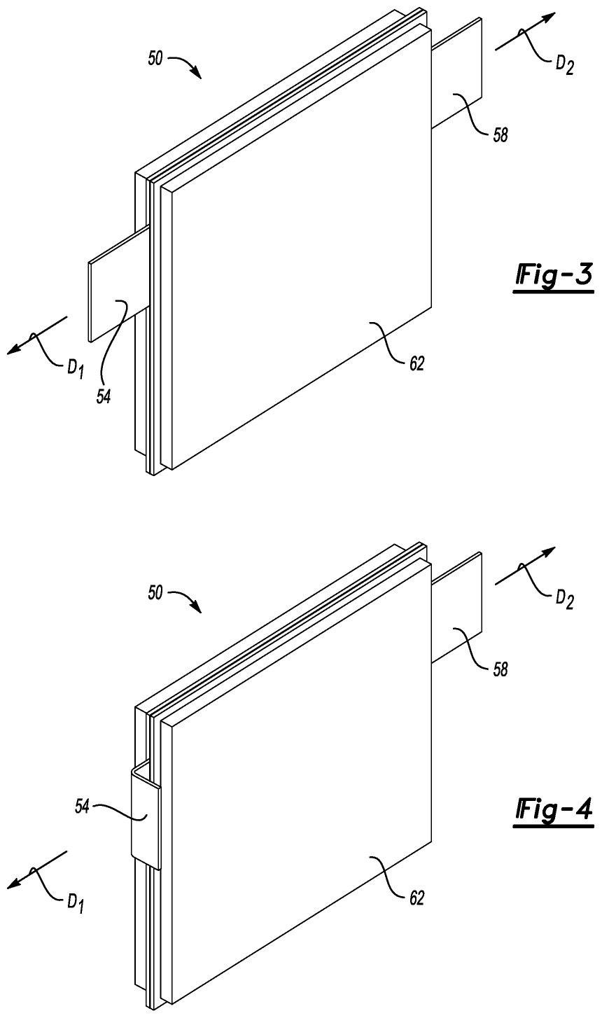

With reference now to FIGS. 2 and 3, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example. Cross-members 46 are positioned between the cell stacks 30 within the interior area 44.

Each of the cell stacks 30 includes, among other things, a plurality of battery cells 50 (or simply “cells”) and a plurality of dividers 52 distributed along a respective cell stack axis A. The battery cells 50 are stacked side-by-side relative to each along the cell stack axis A. In this example, the axes of the cell stacks 30 and the cross-members 46 are parallel to each other and extend longitudinally in a cross-vehicle direction.

The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure.

The exemplary battery cells 50 each include a tab terminal 54 and a tab terminal 58 extending from opposing sides of a battery cell case 62. A multi-layered film can provide the case 62, for example. The tab terminal 54 and the tab terminal 58 can have opposite polarities (i.e., one positive and one negative).

The tab terminal 54, when not bent, extends from the case 62 in a first direction D1, and the tab terminal 58 extends from the case 62 in a second direction D2 that is opposite the first direction. The first direction D1 and the second direction D2 are horizontal in this example. Horizontal and vertical, for purposes of this disclosure, are with reference to ground and a general orientation of battery pack 14 when installed within the vehicle 10 of FIG. 1.

With reference now to FIG. 4 and continued reference to FIGS. 2-3, an exemplary method of assembling the battery pack 14 and, more particularly, assembling one of the cell stacks 30 includes bending at least the tab terminal 54 from the position of FIG. 3 to the position of FIG. 4.

The tab terminal 54 can be a metal, such as copper or aluminum. A press could be used to bend the tab terminal 54. The bending of the tab terminal 54 is with reference to the direction D1. The bending bends the tab terminal 54 about ninety degrees in this example. After the bending, portions of the tab terminal 54 are oriented perpendicular to other portions of the tab terminal 54.

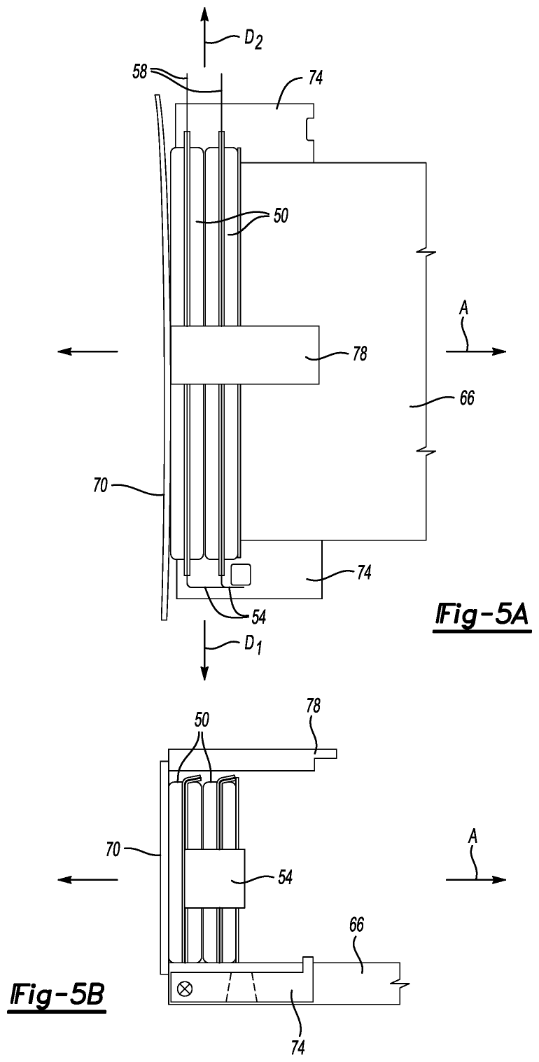

With reference to FIGS. 5A and 5B, after the bending, the battery cell 50 can be positioned along with another battery cell 50 along the axis A atop a thermal exchange plate 66 and against an endplate 70. Fixtures 74 and 78 are used to hold the positions of the battery cells 50 as the battery cells 50 are positioned along the axis A.

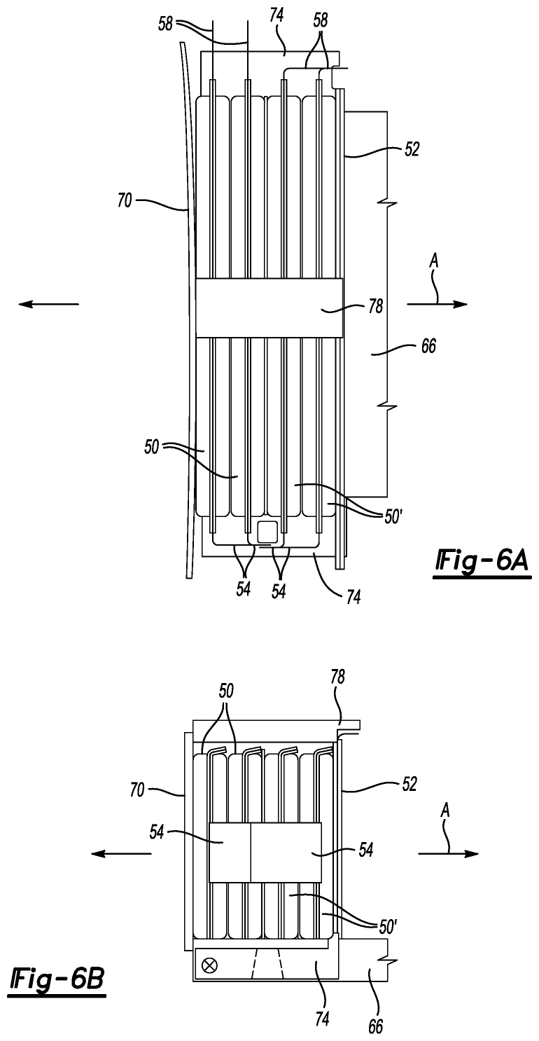

Referring to FIGS. 6A and 6B, additional battery cells 50′ are then added along the cell stack axis A. The battery cells 50′ has tab terminals 54 that are bent, but bent an opposite direction to the bend of the tab terminals 54 of the battery cells 50. Further, the tab terminals 58 of the battery cells 50′ are bent in an opposite direction to the tab terminals 54 of the battery cells 50′. The bending of the tab terminals 58 is with reference to the direction D2.

For the battery cells 50′, the tab terminals 54 are bent such that portions of the tab terminals 54 extend axially in a first axial direction, and portions of the tab terminals 58 extend axially in an opposite, second axial direction.

After positioning the battery cells 50′, one of the dividers 52 is then positioned against the battery cells 50′ along the axis A. The dividers 52 can help to compartmentalize battery cells 50 of the cell stacks 30.

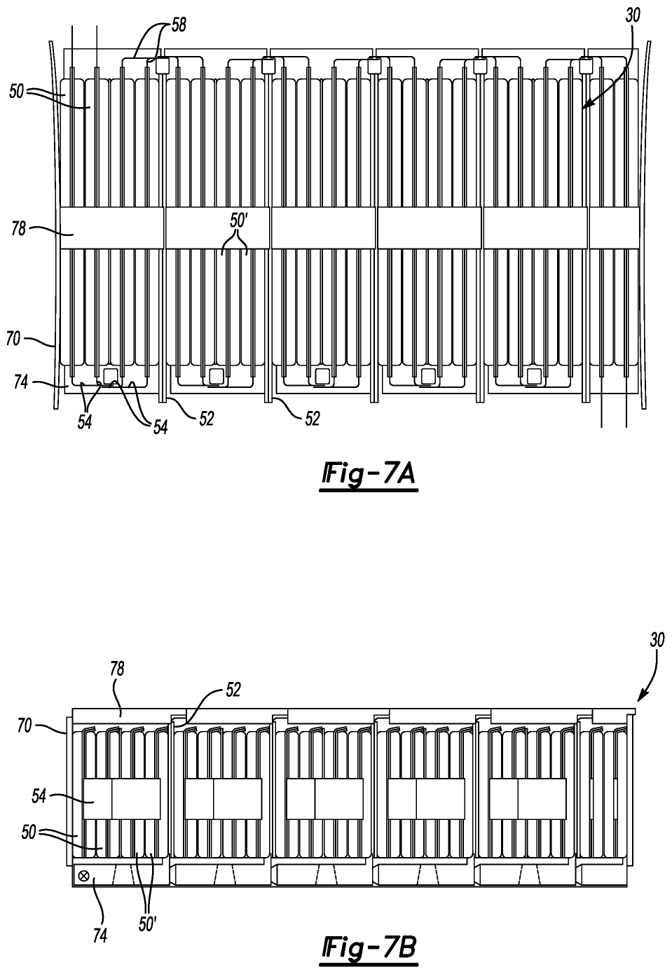

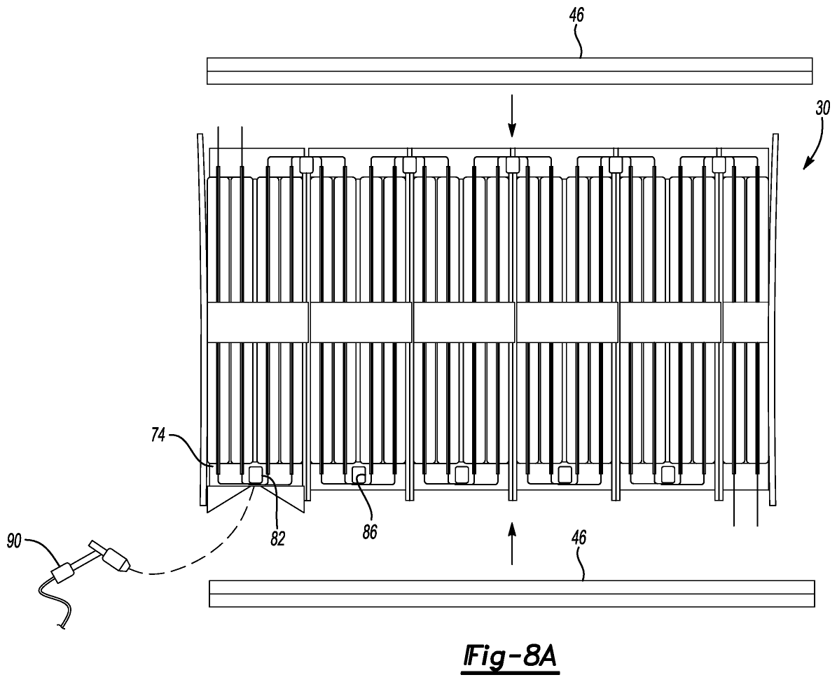

The placement of additional battery cells 50, dividers 52, and appropriate fixtures 74 and 78 continues until the cell stack 30 is complete as shown in FIGS. 7A and 7B.

Next, selected tab terminals 54 or 58 are secured together, which electrically connects the tab terminals 54 and 58. In this example, the tab terminals 54 of the battery cells 50 are secured to the tab terminals 54 of the battery cells 50′ with welds 80. The securing occurs after bending the tab terminals 54 and the tab terminals 58.

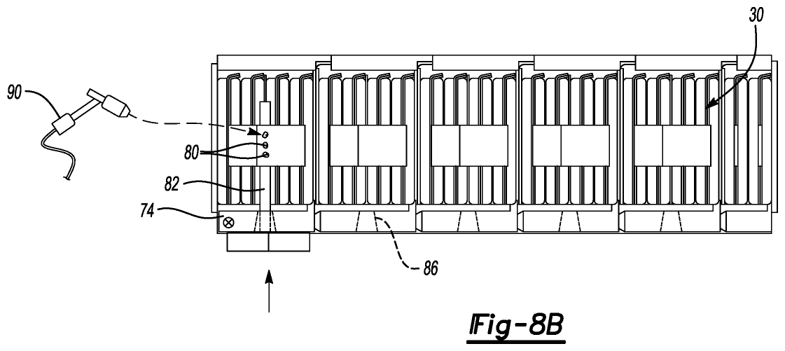

During the securing, a backer tower 82 is inserted behind the tab terminals 54 of the battery cells 50 and the battery cells 50′ as shown in FIGS. 8A and 8B. The backer tower 82 is received within an aperture 86 of the fixtures 74 when inserted behind the tab terminals 54, which can help to properly position the backer tower 82. The backer tower 82 is inserted such that the backer tower 82 is positioned between the tab terminals 54 and the cases 62 of the battery cells 50 and 50′. Along with the backer tower 82, weld splatter protection shields may be positioned near the cell stack 30 in areas needing welding.

A welder 90 can then press the tab terminals 54 against the backer tower 82 and apply the welds 80 to secure together the tab terminals 54 of the battery cells 50 and 50′. After welding, the backer tower 82 is withdrawn from behind the tab terminals 54 and from the aperture 86.

The backer tower 82 can then be inserted into another aperture 86 to provide a backer as other groups of the tab terminals 54 or 58 are secured via welds. The welding continues until the desired groups of terminals 54 and 58 are joined. This electrically connects together all the battery cells 50 of the cells stack 30.

In this example, the tab terminals 54 that are bent are welded to other tab terminals 54 that are bent, and the tab terminals 58 that are bent are welded to other tab terminals 58 that are bent.

The battery cells 50 at one axial end of the cell stack 30 includes tab terminals 58 that are not bent. The battery cells 50 at the other axial end of the cell stack 30 includes tab terminals 54 that are not bent. These tab terminals 54 and 58 that are not bent can be secured to a busbar assembly, for example, to electrically connect the cell stack 30 to other area of the battery pack 14.

After completing welds within the cell stack 30, the cross-members 46 are positioned adjacent the tab terminals 54 on one side of the cell stack 30 and adjacent the tab terminals 58 on the opposite, second side of the cell stack 30. The cross-members 46 sandwich the tab terminals 54 and 58 that are bent against the cases 62 of the battery cells 50 in the cell stack 30. The tab terminals 54 and 58 that are bent do not extend through apertures in the cross-members 46. The endplates 70 at opposing ends of the cell stack 30 can be attached to the cross-members 46. In this example, the endplates 70 are flexible and can snap-fit to the cross-members 46 in some examples.

The fixtures 74, 78 and the backer tower 82 are then removed prior to positioning the cell stack 30 within the enclosure assembly 34.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A method of assembling a battery pack, comprising:
bending at least one first tab terminal of at least one first battery cell and then positioning the at least one first battery cell along an axis of a cell stack;
bending at least one second tab terminal of at least one second battery cell and then positioning the at least one second battery cell along the axis of the cell stack; and
securing the at least one first tab terminal to the at least one second tab terminal after bending the at least one first tab terminal and the at least one second tab terminal.

2. The method of claim 1, wherein the securing electrically connects the at least one first tab terminal to the at least one second tab terminal.

3. The method of claim 1, further comprising securing the at least one first tab terminal to the at least one second tab terminal with at least one weld.

4. The method of claim 1, further comprising, prior to the securing, inserting a backer tower between the at least one first tab terminal and a case of the at least one first battery cell, and between the at least one second tab terminal and a case of the at least one second battery cell.

5. The method of claim 4, further comprising securing the at least one first tab terminal to the at least one second tab terminal by welding against the backer tower.

6. The method of claim 1, wherein the at least one first tab terminal extends from a case of the at least one first battery cell in a direction, wherein bending the at least one first tab terminal is a bending with reference to the direction.

7. The method of claim 1, wherein, after bending the at least one first tab terminal, portions of the at least one first tab terminal extend axially in a first direction, wherein, after bending the at least one second tab terminal, portions of the at least one second tab terminal extend axially in a second direction opposite the first direction.

8. The method of claim 1, wherein, after bending the at least one first tab terminal, portions of the at least one first tab terminal are oriented perpendicular to other portions of the at least one first tab terminal.

9. The method of claim 1, further comprising, after the securing, positioning a cross-member adjacent the at least one first tab terminal and the at least one second tab terminal such that the at least one first tab terminal and the at least one second tab terminal are sandwiched between the cross-member and cases of the at least one first battery cell and the at least one second battery cell.

10. The method of claim 1, wherein the at least one second tab terminal is on a first side of the cell stack, and further comprising securing at least one second tab terminal on an opposite, second side of the at least one second battery cell to at least one third tab terminal of at least one third battery cell.

11. The method of claim 10, further comprising, prior to securing the at least one second tab terminal on the second side to the at least one third tab terminal, bending the at least one second tab terminal on the second side, and bending the at least one third tab terminal.

12. The method of claim 1, wherein the at least one first battery cell and the at least one second battery cell are battery cells of a traction battery pack.

13. The method of claim 1, wherein the at least one first battery cell and the at least one second battery cell are lithium-ion pouch cells.

14. The method of claim 1, wherein the at least one first battery cell includes two first battery cells each having one first tab terminal, and the at least one second battery cell includes two second battery cells each having one second tab terminal.

15. The method of claim 14, wherein the securing includes securing the first tab terminals of the two first battery cells directly to the second tab terminals of the two second battery cells.

16. A battery pack assembly, comprising:
a first battery cell having a first tab terminal extending from a first case;
a second battery cell having a second tab terminal extending from a second case; and
a cross-member, the first and second tab terminals joined to each other and sandwiched between the cross-member and the first and second cases.

17. The battery pack assembly of claim 16, wherein the first and second battery cells are lithium-ion pouch cells.

18. The battery pack assembly of claim 16, wherein the first and second tab terminals are directly joined to each other with at least one weld.

19. The battery pack assembly of claim 16, wherein the first and second battery cells are constituents of a traction battery pack.
